(19) United States
(12) Patent Application Publication
(10) Pub. No.: US 2026/0309879 A1
(43) Pub. Date: Oct. 8, 2026

(54) Combined Plenoptic (Depth-of-Field) Assisted Tomography

(71) Applicant: UNM Rainforest Innovations, Albuquerque, NM (US)

(72) Inventors: Adam Alexander Hecht, Albuquerque, NM (US); Dominic Lioce, Albuquerque, NM (US); Jesus Valencia, Albuquerque, NM (US)

(73) Assignee: UNM Rainforest Innovations, Albuquerque, NM (US)

(21) Appl. No.: 19/088,862

(22) Filed: Mar. 24, 2025

Related U.S. Application Data
(60) Provisional application No. 63/569,060, filed on Mar. 22, 2024.

(51) Int. Cl. G01T 1/29; G06T 7/557; G06T 12/10; G06T 12/20

(52) U.S. Cl. CPC G01T 1/2985; G06T 7/557; G06T 12/10; G06T 12/20; G06T 2200/04; G06T 2207/10052; G06T 2207/10081; G06T 2207/20212

(57) ABSTRACT

A method for depth of field imaging assisted tomography for producing an image of an object combining depth-of-field information from several orientations to make a combined-depth-of-field (CDOF) image.

### RELATED APPLICATIONS

This application claims priority to U.S. Provisional Application No. 63/569,060, filed on Mar. 24, 2024, which is incorporated herein in its entirety.

### STATEMENT REGARDING FEDERALLY SPONSORED RESEARCH & DEVELOPMENT

This invention was made with government support by the Department of Energy grant DE-NA0003920. The government has certain rights in the invention.

INCORPORATION BY REFERENCE OF MATERIAL SUBMITTED ON A COMPACT DISC

Not applicable.

### BACKGROUND OF THE INVENTION

Standard tomographic imaging uses 2D projection images at different object-detector orientations, combining the image information and angle/position information to perform a 3D image reconstruction. This is typically performed with backprojection, with various filtering to improve image quality. A 2D image may be created by backprojections of 1D intensity profiles of the object as imaged from different orientations. See FIG. 1. In medical imaging, the backprojection can follow several steps. A sinogram is typically created, with the orientation angle and intensity profile filling the sinogram using a Radon transformation. This is not the image but has the information to make the image. The inverse Radon transform then uses that information to make the image.

Other modes of 3D imaging exist, such as a light field camera, also called a plenoptic camera. A plenoptic camera may use many small lenses and photodetectors to capture many images from slightly different positions, like stereoscopic vision but with more detectors. The many different sub-images then may be used in post-processing to adjust the depth of field. That is, the focus may be changed to different depths in the image. which moves different objects in and out of focus in the image reconstructed from many recorded sub-images. A figure of a lens array, many sub-images, and image reconstruction at different depths of field are shown in FIG. 2.

In the plenoptic depth-of-field imaging examples, single images are presented with a particular chosen focal plane, but the data used to produce these 2D images contains the depth information and thus there is 3D information as can be seen in the refocusing. It is almost certain that the depth of field (z direction) information is not as sharp as the lateral (x and y) information, though this is still depth information.

The word plenoptic is commonly used for imaging with optical cameras but to be more general, the present invention uses the term depth-of-field.

It appears that techniques from backprojection imaging and plenoptic depth-of-field imaging can be combined in a useful way. If depth-of-field information is determined from several different views then the poor resolution in the original depth (z) direction can be improved quickly.

### SUMMARY OF THE INVENTION

In one embodiment, present invention concerns combining depth-of-field information from several orientations to make a combined-depth-of-field (CDOF) image.

This technique makes a determination of positions of objects all 3 dimensions resolve more sharply than a single depth-of-field image. This technique also makes a determination of the positions of objects in all 3 dimensions resolve more quickly, meaning with fewer images from different detector-object orientations, than in backprojection imaging.

In another embodiment, the present invention concerns depth-of-field imaging assisted tomography.

In another embodiment, the present invention concerns depth-of-field imaging assisted tomography that improves images with limited data set sizes.

In another embodiment, the present invention concerns depth-of-field imaging assisted tomography that improves muon imaging.

In another embodiment, the present invention concerns depth-of-field imaging assisted tomography that improves proton radiography imaging.

In another embodiment, the present invention concerns depth-of-field imaging assisted tomography that improves 3D image reconstruction with visible light, if several positions of a plenoptic camera are used.

In another embodiment, the present invention concerns depth-of-field imaging assisted tomography that improves medical radiography.

In another embodiment, the present invention concerns depth-of-field imaging assisted tomography where there is Compton scatter wherein a photon will have a different angle that can be tracked back to the scattering point in the body. The scatter angle and energy are related so with energy sensitive detectors in a CT scanner a depth-of-field effect is added.

In another embodiment, the present invention concerns plenoptic imaging assisted tomography.

In another embodiment, the present invention concerns plenoptic imaging assisted tomography that improves images with limited data set sizes.

In another embodiment, the present invention concerns plenoptic imaging assisted tomography that improves muon imaging.

In another embodiment, the present invention concerns plenoptic imaging assisted tomography that improves proton radiography imaging.

In another embodiment, the present invention concerns plenoptic imaging assisted tomography that improves 3D image reconstruction with visible light by using several positions of one or more plenoptic cameras.

In another embodiment, the present invention concerns plenoptic imaging assisted tomography that improves medical radiography.

In another embodiment, the present invention concerns plenoptic imaging assisted tomography where there is Compton scatter resulting in a photon having a different angle that can be tracked back to the scattering point in the body using energy sensitive detectors in a CT scanner. This adds a plenoptic effect since the scatter angle and energy are related.

In another embodiment, the present invention concerns using data from several different detector-object orientations as in traditional tomography with multiple planar images.

In another embodiment, the present invention concerns making 3D images from each orientation rather than 2D planar images as well as combining plenoptic images from several different detector-object orientations with the assumption of rotation or reorientation of one or the other for each plenoptic image, or at least different detectors in a set of detectors.

In another embodiment, the present invention concerns combining formed plenoptic images from different detector-object orientations.

In another embodiment, the present invention concerns upright detector planes that may be moved or in several positions around an object to image whereby the muon flux is more vertical resulting in image adding to resolve a tomographic image quickly with low data to achieve an enhanced fit to this lower flux orientation.

### BRIEF DESCRIPTION OF THE SEVERAL VIEWS OF THE DRAWINGS

The drawings, which are not necessarily drawn to scale, like numerals, may describe similar components throughout the several views. For example, numerals with different letter suffixes may represent different instances of similar components. The drawings illustrate, by way of example, but not by limitation, a detailed description of specific embodiments discussed in the present document.

FIGS. 1A, 1B and 1C show backprojection imaging by combining 1D intensity profile images at different detector-object orientations.

FIG. 2 shows depth of field imaging.

FIG. 3 shows a muon tracking array for an embodiment of the present invention.

FIG. 4 shows high, medium, and low scatter angle muons that can be tracked to different positions at different distances from a detector array.

FIG. 5A shows images reconstructed at Z=0 cm.

FIG. 5B shows images reconstructed at Z=15 cm.

FIGS. 6A and 6B show depth-of-field tomographic slices of an object.

FIG. 7A shows muon tracks coming from the top of an object.

FIG. 7B shows muon tracks coming from the right of an object.

FIG. 8A shows depth-of-field image with 5 million muons from a single orientation.

FIG. 8B shows depth-of-field image with combined-depth-of-field image from about 5 million muons total.

FIG. 8C shows depth-of-field image with an improved image obtained with an embodiment of the present invention.

FIG. 9 depicts muon imager detectors around an object to be imaged wherein the detector planes are on their sides.

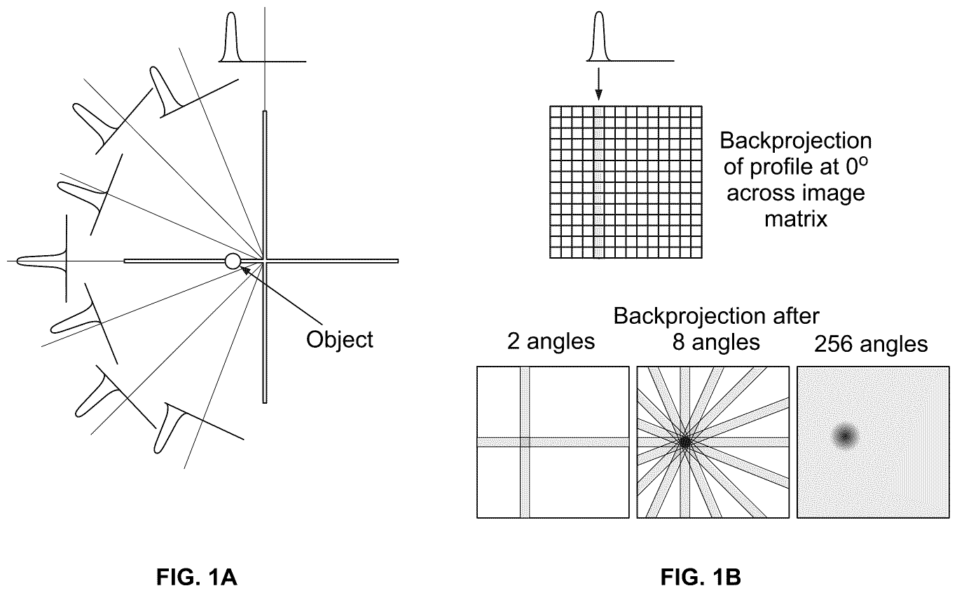

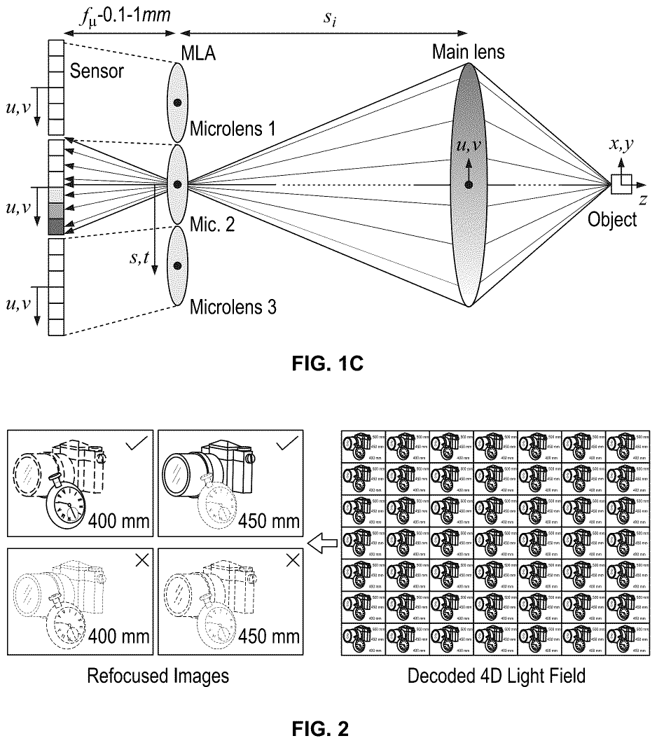

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

In one aspect, the present invention combines the depth information from depth-of-field imaging at different object-detector orientations to perform tomographic imaging.

In one aspect, the present invention uses depth of field imaging from several different orientation angles. As the data set at each orientation contains depth (z) information, it informs the 3D reconstruction. The definition of the depth direction (z) of course changing relative to the orientation.

In other embodiments, the present invention concerns both photon imaging, including optical, and more penetrating imaging in which the radiation direction may be recorded, such as with muons.

As an example, muons are highly penetrating charged particles and can be used for imaging within large and dense objects. In nature, they are produced in the upper atmosphere by cosmic ray interactions and reach the surface of the Earth with a mostly vertical bias, but there is a width to the distribution. Muons interact primarily with the electrons in material, deflecting slightly with each interaction. The muons scatter laterally more through high atomic number and high density objects, so the scatter angle information is important to imaging. The total scatter angle for each muon is dependent on the integral of interactions over the entire path.

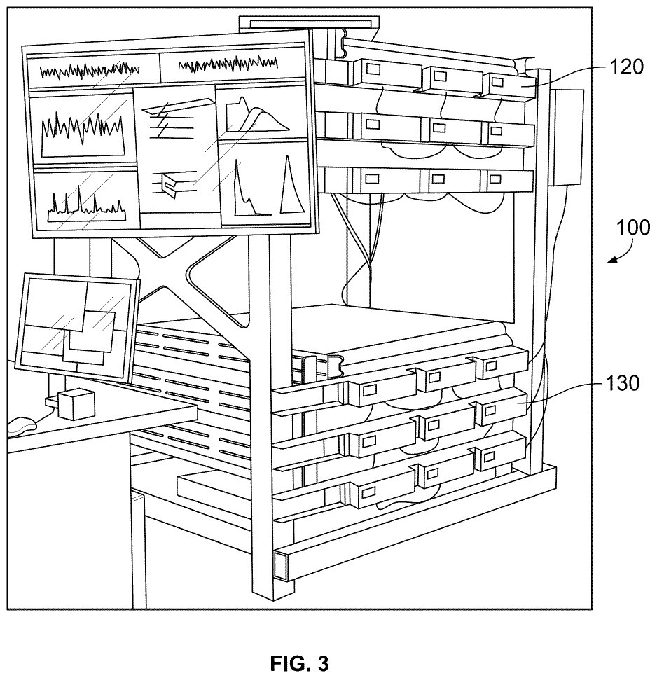

To find the path the muon travelled in the object and the total scattering angle along the path, tracking detectors are used on opposite sides of an object that is to be imaged, and the position and angle of each muon is determined before and after it interacts. A tracking array 100 is shown in FIG. 3. The detectors in the figure are sets of drift tubes arranged in an upper module 120 and lower module 130. An object to be imaged can be placed between the modules. The position and angle of the muons in the top and bottom modules can be determined, and scatter information extracted for each muon.

For backprojection imaging, a sinogram may be formed, and the average scatter angle recorded at each lateral position on the detector, as well as the detector-object orientation, are recorded. This information can then be backprojected to form an image of the object, with image information on the interior of the object.

On the other hand, natural muons are coming in over a range of angles, which means tracking the angles with the detector gives views of the object from several different angles for a single detector-object orientation. This allows for depth-of-field imaging.

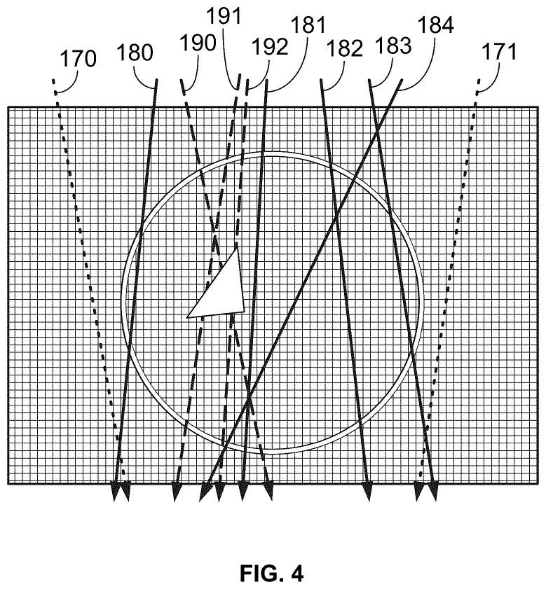

As an example of depth-of-field imaging is the use of a container filled with concrete and a metal wedge is considered. The muons travel in nearly a straight line, but there is enough scatter to record differences. FIG. 4 shows the muon paths as simply straight lines. The muons that pass through just air outside of the container are labeled as 170-171 and have very low scattering. The muons that pass through the concrete are labeled as 180-184 and experience more scattering. The muons that pass through the tungsten object (a wedge) inside the container (a barrel) (and also the concrete before and after it) are labeled as 190-192 and experience the most scattering. In this particular algorithm, the space may be voxelized and the amount of scattering can be added to each voxel the muons pass through. It can be seen that the paths (190-192) converge on where the object (tungsten wedge) is. Since the muons do not all pass through going straight down, there is some amount of depth information in this. The space can be separated into vertical slices and the scattering high intensity comes into focus at the height of the wedge, providing a depth as well as lateral image of the wedge within the barrel, from a single detector-object orientation.

Specifically, the scattering intensity of the muons can be tracked through different positions at different distances from the bottom (or top) detector array, with a model of the concrete filled barrel with a metal wedge inside. This is presented in a voxelized space for reconstruction. The high scattering intensity muons converge at the height that they encountered the high density object.

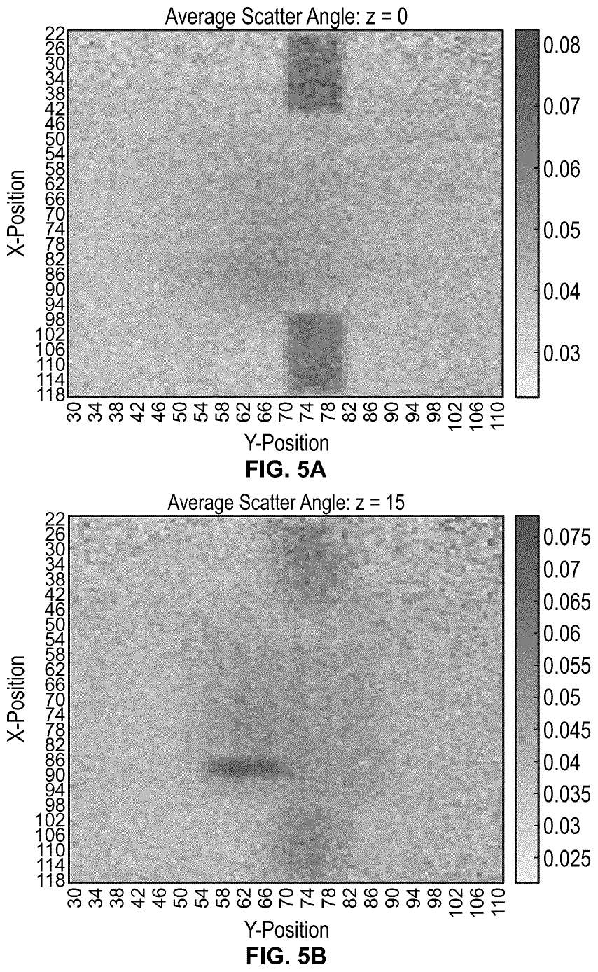

Example height slice images from different heights are shown in FIG. 5.A and 5B. These are average scatter intensity images over the voxels in the x-y plane, with different z (height or depth) values for different images. At the top and bottom of the images are the handles for the carriage the barrel sat in. The concrete barrel is less visible. A tungsten wedge in the barrel is not seen at the height of the slice in the z=0 cm image (FIG. 5A) but appears at the heigh imaged in the z=15 cm image slightly off center towards the bottom left (FIG. 5B).

A y-z tomographic slice image can be made using a tomographic slice from the depth of field information at a single x value along the barrel, cutting across the barrel and cutting through the wedge. We can look at y and z information and get the z depth-of-field information from the stacking more slices like those in FIGS. 5A and 5B. The image is stretched in z, the depth-of-field direction.

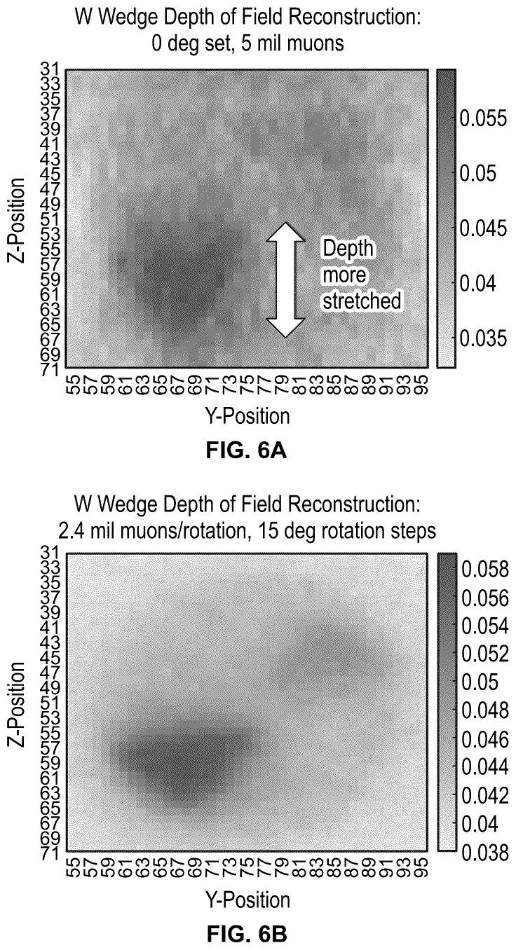

FIG. 6 shows depth-of-field tomographic slices of a tungsten wedge inside a barrel, using muons. The z direction is between the detector faces, the depth (or height) direction in this depth-of-field reconstruction. This is a perpendicular slice of stacked reconstruction images from different z values, z being the direction between the detectors. Color intensity corresponds to the average scatter angle of the muons that pass through each voxel. FIG. 6A shows a single detector-object orientation for typical depth-of-field image. FIG. 6B shows a more thorough imaging to give a sense of positioning of the wedge inside the barrel. The depth stretching of the wedge can be seen in the single orientation depth-of-field image.

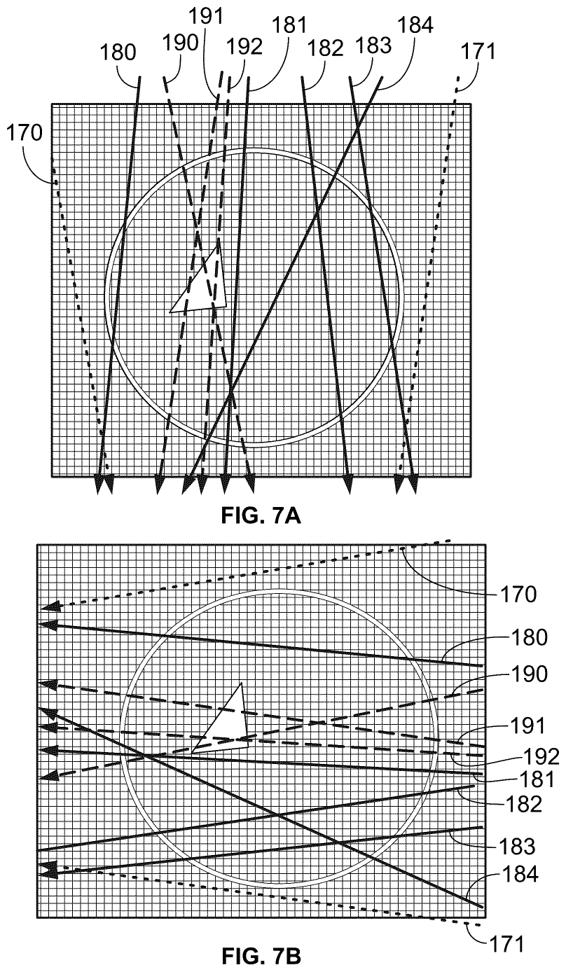

In another embodiment, instead of performing a depth-of-field imaging from a single orientation, the present invention performs depth-of-field imaging from several orientations. In the example with muon imaging of the concrete barrel, the image of the wedge in the depth direction from that particular orientation is stretched, showing the worse resolution along the depth direction. Information can be combined from different orientations, and an example of muon tracks from several orientations is shown in FIG. 7. In this example, the object was reoriented rather than the detector, since the muons come primarily from above, and the grid follows the barrel direction, but it is the relative reorientation that is important. The depth in the first figure is now a lateral direction in the second figure, quickly resolving the depth stretching seen in the image of the wedge from the first orientation.

Specifically, FIGS. 7A and 7B show muon tracks. FIG. 7A shows tracks coming from the top. FIG. 7B shows tracks coming from the right.

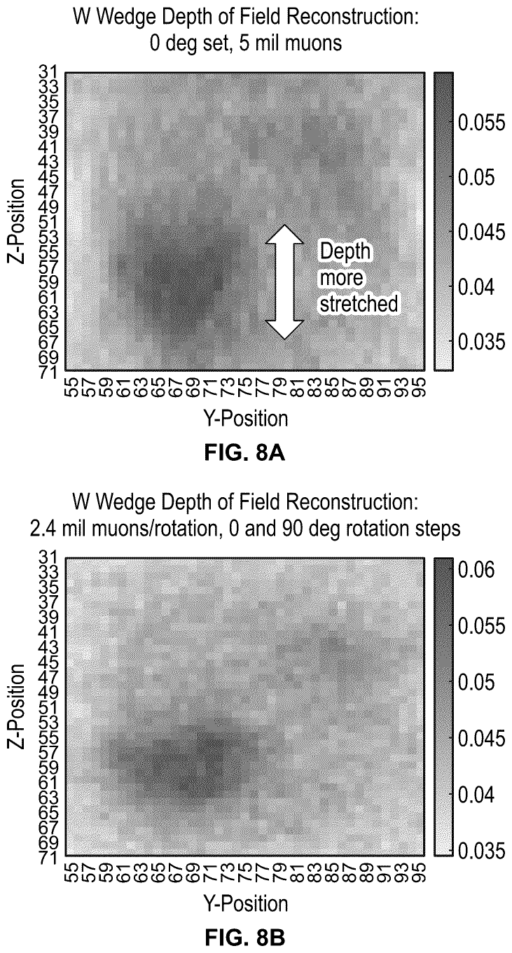

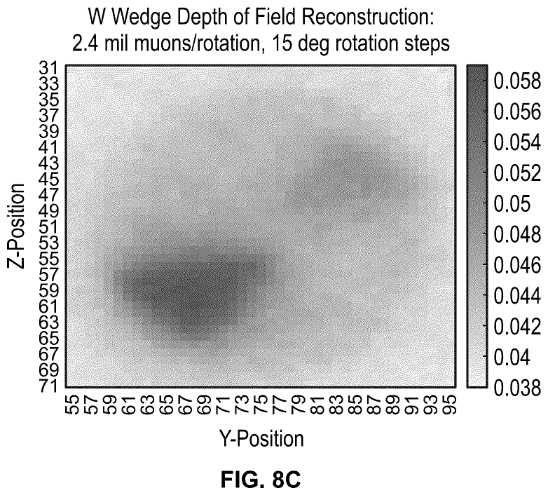

The original image with 5 million muons from one detector-object orientation creating a depth-of-field image with some smudging in the depth (z) direction is shown in FIG. 8A. The new image with about 5 million muons total, but from two different orientations with 2.4 million muons each, is shown in FIG. 8A. This is a demonstration of a combined-depth-of-field image. The improvement in the original z direction can be seen immediately, and a second wedge that is made of brass now also becomes visible at the top right, though it was too smudged in the traditional single-orienation depth-of-field image. A higher data combined-depth-of-field image from 24 orientations is shown in FIG. 8C to understand wedge positioning. The circular shape of the barrel can also be seen.

The container (barrel) was rotated to get different barrel-detector angles (equivalent to moving the detector panels around a stationary object). Instead of having a 2D intensity projection image for each orientation which is then backprojected to create a 3D image as with traditional tomography, each detector-object orientation gives 3D information which can be combined to create a combined 3D image with higher resolution, and/or more quickly, than from a single orientation.

For muon imaging, the natural muons come primarily from above with a cosine squared distribution from the zenith angle. The similarity in muon flux for all detector-object orientations assists in the reconstructions but is not necessary.

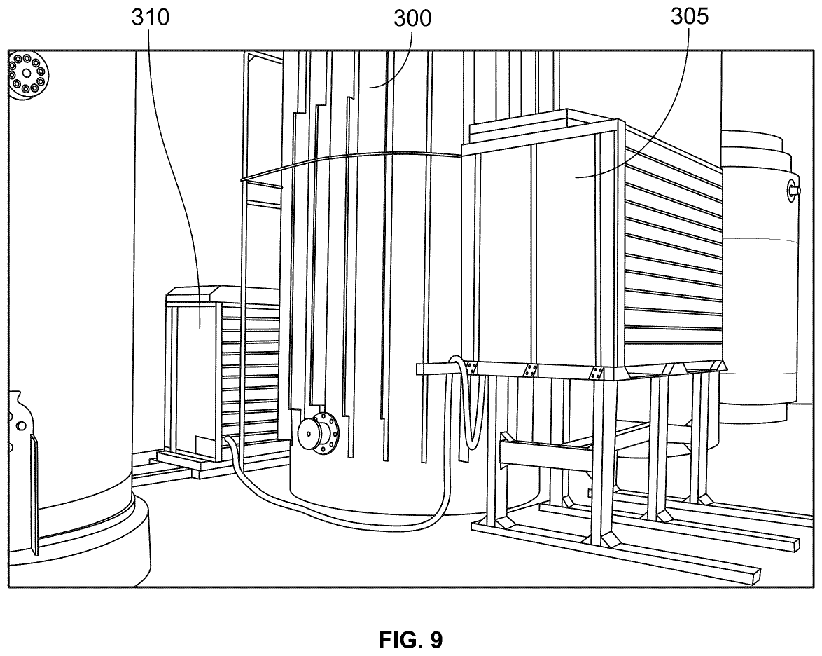

For muon imaging of an object 300, which may be a spent nuclear fuel cask standing on a cask pad, detectors 305 and 310 cannot be put underneath the cask but are on either side of the cask with one raised higher than the other to make use of the higher flux at lower zenith angles. This can be seen in FIG. 9. The casks interior may be imaged using depth-of-field imaging. Reorienting the detectors around the cask with the same height offset will give a very similar muon spectrum and flux and combined-depth-of-field imaging could be performed. In this case, the detectors can be moved instead of the object to create different detector-object orientations.

Thus, the above system provides a method for depth of field imaging assisted tomography for producing an image of an object comprising the steps of: providing a plurality of arrays 305 and 310 that are comprised of one or more detectors located around the object to be imaged; obtaining multiple depth-of-field 3D images from several different detector orientations; and creating a combined 3D image of the object.

In traditional tomography, back projection is used. In the present invention, 3D images from each object-detector angle are combined for several object-detector angles and the image converges much faster than in traditional back projection. This increases object-background contrast not only in one direction but several since several angles are used. This also allows for an image to converge with very little data, which is extremely useful for tomography.

In other aspects, the embodiments of the present invention may be used in ways to apply them to combining visible light plenoptic depth imaging, and to apply them to scatter information in x-ray imaging to enhance tomography.

### Applications

The embodiments of the present invention may be useful for improving images with limited data set sizes such as muons, charged particles, and photons-including x/gamma, visible, and perhaps other wavelengths.

The embodiments of the present invention may be useful for proton radiography imaging, which is performed at pRad at LANL and other labs.

### Visible light

The embodiments of the present invention may be useful for 3D image reconstruction with visible light, if several positions of a plenoptic camera are used. The plenoptic depth has more uncertainty than the lateral information (for a camera that's really just lateral angles). Performing 3D image reconstruction from a standard image for cameras at several angles with standard back projection requires many detector positions to converge well. With plenoptic imaging there is more information from each camera-object orientation and the reconstructed image will converge with fewer camera positions.

### X-Rays

The embodiments of the present invention may be useful for applications involving medical radiography. For example, in tomography if there is Compton scatter, that photon will have a different angle that can be tracked back to the scattering point in the body. The scatter angle and energy are related so with energy sensitive detectors in a CT scanner may be able to add this plenoptic effect.

Even without good energy sensitivity, and a broad energy x-ray beam, photons scattered out of the main beam in tomography may be noted and a probable scatter angle, or range of probabilities for a range of scatter angles, be determined and applied in the method of Compton scatter cameras, to add to simple projection data.

In other embodiments, the present makes 3D images from each orientation rather than 2D planar images. In a preferred embodiment, the present invention combines plenoptic images from several different detector-object orientations with the assumption of rotation or reorientation of one or the other for each plenoptic image, or at least different detectors in a set of detectors.

This is in contrast to subsets of zenith angles to create different plenoptic images that then may be combined, as in a patent by Decision Sciences.

This is also different from using different cones of azimuth angle range for the same detector-object orientation.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A method for depth of field imaging assisted tomography for producing an image of an object comprising the steps of: providing a plurality of arrays, said arrays comprised of one or more detectors located around the object to be imaged;
obtaining multiple planar images from several different detector orientations; and
creating a 3D image of the object.

2. The method of claim 1 further comprising the step of combining plenoptic images from several different detector-object orientations.

3. The method of claim 2 further comprising the step of changing the orientation of said arrays with respect to the object.

4. The method of claim 3 further comprising the step of changing the position of the object with respect to said arrays.

5. The method of claim 1 further comprising the step of combining formed plenoptic images from different detector-object orientations.

6. The method of claim 1 further comprising the step of creating detector planes oriented horizontally with vertical space between said detectors.

7. The method of claim 1 further comprising the step of combining depth information from plenoptic imaging at different angles to perform tomographic imaging.

8. The method of claim 1 further comprising the step of combining depth information from plenoptic imaging at different angles to perform tomographic imaging wherein the information not only has lateral (x) information but contains at depth z information to create a 3D reconstruction of the object.

9. The method of claim 8 wherein 3D images are created from each orientation rather than from 2D planar images.

10. The method of claim 8 wherein the imaging has the same intensity in voxels in a line at all distances from the detector and the intensity is constrained by the plenoptic information.

11. The method of claim 8 further including the step of combining 3D plenoptic information from the different angles.

12. A method for plenoptic imaging assisted tomography for producing an image of an object comprising the steps of: positioning a plurality of muon tracker arrays around an object to be imaged to create an object-detector orientation; using said arrays to track the position and angle of muons going in and muons going out of an object; tracking said muons back to a center plane and mapping on the scatter distribution of all muons that pass through different pixels in the plane; mapping onto pixels the average scatter angle of the distribution in a pixel; and performing backprojection imaging.

13. The method of claim 12 further comprising the step of recording muon trajectories and positions at different planes of the object.

14. The method of claim 13 further comprising the step of grouping the muons into a pixel they go through at a particular height of the object to obtain average scatter angles.

15. The method of claim 14 further comprising the step of determining the location where the muons converge as the height that the muons encountered the object.

16. The method of claim 12 wherein the plane of the array is perpendicular to a horizontal direction of the object.

17. The method of claim 13 wherein said object-detector orientation are object-detector angles and 3D images from each object-detector angle are combined for several object-detector angles.

18. The method of claim 17 wherein 3D images from each image-detector angle are obtained rather than 2D planar images.

19. The method of claim 13 wherein several different detector-object orientations are obtained by the reorientation of said arrays with respect to the object.

20. The method of claim 13 wherein several different detector-object orientations are obtained by the reorientation of the object with respect to said arrays.
